(19) United States
(12) Patent Application Publication
(10) Pub. No.: US 2016/0249144 A1
(43) Pub. Date: Aug. 25, 2016

(54) METHOD FOR ASCERTAINING WEARER-SPECIFIC USE DATA FOR A HEARING AID, METHOD FOR ADAPTING HEARING AID SETTINGS OF A HEARING AID, HEARING AID SYSTEM AND SETTING UNIT FOR A HEARING AID SYSTEM

(71) Applicant: SIVANTOS PTE. LTD., SINGAPORE (SG)

(72) Inventor: CLAUS REINLEIN, BURGTHANN (DE)

(21) Appl. No.: 15/052,129

(22) Filed: Feb. 24, 2016

(30) Foreign Application Priority Data
Feb. 24, 2015 (DE) 102015203288.4

(51) Int. Cl. H04R 25/00

(52) U.S. Cl. CPC H04R 25/70; H04R 25/558; H04R 2225/39; H04R 2225/55

(57) ABSTRACT

An analysis unit is associated with a hearing aid but formed separately therefrom and set up for unidirectional signal transmission to the hearing. The analysis unit is used to ascertain a wearer-specific problem with the current operating state and storing the problem in the analysis unit as a first data record element. The analysis unit then outputs a control signal to the hearing aid, with reception thereof prompting the hearing aid to store a number of operating data as a second data record element. These two data record elements are later retrieved from the analysis unit and the hearing aid by a setting unit, connected and evaluated, and then new hearing aid settings are ascertained for the hearing aid.

### CROSS-REFERENCE TO RELATED APPLICATION

This application claims the priority, under 35 U.S.C. §119, of German patent application DE 10 2015 203 288.4, filed Feb. 24, 2015; the prior application is herewith incorporated by reference in its entirety.

### BACKGROUND OF THE INVENTION

### Field of the Invention

The invention relates to a method for ascertaining wearer-specific use data for a hearing aid and to a method for adapting hearing aid settings. Furthermore, the invention relates to a hearing aid system and to a setting unit for such a hearing aid system.

Hearing aids are conventionally used by persons with restricted hearing to at least partly compensate for the reduction in their hearing. For this purpose, hearing aids usually comprise a microphone (if need be even multiple microphones) for picking up sounds from the surroundings (i.e. particularly speech and music and also other sound signals) and a loudspeaker (frequently also called an “earphone”) for forwarding the picked-up ambient sounds to an ear of the hearing aid wearer. As an alternative to the loudspeaker, the hearing aids can also have other transmission apparatuses for the ear or the auditory center of the hearing aid wearer (for example special implants for transmitting sound to a cranial bone or what is known as a cochlea implant). To amplify and/or otherwise process the sound signals picked up via the microphone (or the microphones), conventional hearing aids contain a control unit that is connected between the microphone and the loudspeaker.

The control unit is regularly set up to amplify the picked-up sound signals differently on the basis of frequency, so that, by way of example, sound signals in the frequency bands in which the sound of the human voice lies are amplified more than other sound signals, such as ambient noise. Since each hearing aid wearer has a specific, possibly frequency-dependent, impairment to his hearing, the control unit of the hearing aids is particularly also set up to be individually adjusted to suit the respective hearing aid wearer or his hearing in respect of the reproduction characteristics of the picked-up sound signals. By way of example, this adjustment involves the values for a frequency-dependent gain and/or attenuation being preset on a wearer-specific basis.

Furthermore, the control unit usually also contains a chip, referred to as a classifier, that is set up and provided to use the characteristics of the picked-up sounds (i.e. the picked-up sound signals) to identify a hearing situation. By way of example, such a hearing situation is a quiet conversation between the hearing aid wearer and a second person or is television. In these two hearing situations, there is usually only a small proportion of (undesirable) extraneous noise (also referred to as interference signals). Examples of other hearing situations may be a conversation in ambient noise, the hearing aid wearer being in a public open space, in road traffic, in nature or the like (in each case with a comparatively large amount of interference noise). A memory unit associated with the control unit of the hearing aid frequently stores different programs in this case that, when executed, prompt the picked-up sound signals to be amplified or attenuated (and if need be masked out) differently on the basis of the respective hearing situation and hence an output adjusted to suit the respective hearing situation to be provided via the loudspeaker of the hearing aid. In this case, the control unit is usually set up to autonomously (automatically) select the respective program on the basis of the hearing situation identified by the classifier and to perform the signal processing accordingly. Manual setting of the programs is frequently (additionally) also possible in this case, however.

Conventionally, the setting of the (hearing aid) control unit is adjusted to suit the hearing of the hearing aid wearer by specially trained personnel, particularly by a hearing aid acoustician. In this case, the respective settings (parameters) are also adjusted separately for each (operating) program (if need be by using empirical values).

However, even a hearing aid acoustician cannot (predictively) depict every hearing situation and provide the hearing aid wearer with an appropriate test environment for testing the respective tonal characteristics of the hearing aid. The first adjustment of the hearing aid (or of the control unit thereof) is therefore regularly more just a first, coarse approximation to the hearing aid settings that are required for the respective hearing aid wearer for a subjectively comfortable auditory sensation. Problems with the hearing aid—i.e. particularly needs for a different tonal characteristic of the hearing aid depending on a hearing situation—are usually identified by the hearing aid wearer only when a corresponding specific hearing situation also actually exists during use of the hearing aid. More accurate adjustment of the hearing aid to suit the hearing situation that exists at the time of such a problem is then conventionally performed by the hearing aid acoustician at a later time.

### SUMMARY OF THE INVENTION

The invention is based on the object of improving the adjustment of hearing aid settings.

The method according to the invention is used to ascertain wearer-specific use data for a hearing aid and is preferably performed by a hearing aid system (preferably formed by a hearing aid and an analysis unit, which is specifically associated with this hearing aid and separate from the hearing aid). In this case, the analysis unit is set up and provided only for unidirectional signal transmission to the hearing aid (i.e. the analysis unit cannot receive information from the hearing aid). In this case and below, the term hearing aid is understood to mean both a single hearing aid (provided for one ear) and a pair of hearing aids that is provided for both ears of a hearing aid wearer (for catering for binaural needs).

The method involves using the analysis unit specifically associated with the hearing aid to ascertain a wearer-specific problem of the hearing aid wearer with the current operating state of the hearing aid. The ascertained wearer-specific problem is then stored in a memory unit, which is associated with the analysis unit, as part of a first data record element of the operating data that are to be ascertained. The analysis unit then outputs a control signal, preferably wirelessly, to the hearing aid. On reception of the control signal in the hearing aid, a number of preferably hearing-aid-specific operating data for the current operating state of the hearing aid are ascertained and stored in a memory unit of the hearing aid as a second data record element of the use data that are to be ascertained. In this case, both the first data record element and the second data record element are stored in the respective memory unit such that the two data record elements remain stored (in a readable form) in the respective memory unit even after a change in the current operating state of the hearing aid.

The wearer-specific use data of the hearing aid are therefore first a problem of the hearing aid wearer with the hearing aid. By way of example, the ambient noise reproduced is too loud for the hearing aid wearer or he hears his own voice too loudly, too quietly, with reverberation or the like. Second, the wearer-specific use data also comprise current operating data for the hearing aid. In particular, the operating data are input levels for different frequency bands (i.e. the ambient volume), a currently “running” (i.e. executed) program of the hearing aid, (program-dependent) setting values (or also: parameters) for frequency compression, for frequency-dependent gain and/or attenuation, a classification—output by a classifier that may be present in the hearing aid—for the current hearing situation, a value that the hearing aid wearer has currently set for the (output) volume, (in the case of a pair of hearing aids), the balance between the left and right hearing aids, and the like.

The analysis unit is preferably a software application that is set up to ascertain the wearer-specific problem and to output the control signal and that is installed in executable form preferably on a smartphone or alternatively on a remote control associated with the hearing aid. In order to prevent “foreign” hearing aids, i.e. hearing aids of other hearing aid wearers situated close by, from reacting to the control signal of the analysis unit, the analysis unit is, in an expedient embodiment, explicitly geared to the relevant hearing aid (and thus associated therewith) prior to the first sending of the control signal in a method step that is referred to as “pairing” and that is preferably independent of the method according to the invention. The effect achieved by this is that particularly transmission of a hearing-aid-specific address in the control signal means that only the associated (addressed) hearing aid identifies the control signal as such.

Since the two stored data record elements remain stored in the form uninfluenced by a change in the current operating state of the hearing aid, such as the activation of another program or a change in the volume, etc., both data record elements can advantageously be retrieved from the respective memory unit of the analysis unit and of the hearing aid at a later time and used for (re)adjustment of the hearing aid settings, particularly by a hearing aid acoustician. The storage (and particularly the later retrieval) of the two data record elements means that the hearing situation that was present at the time at which the problem occurred and was ascertained by the analysis unit can (at a later time) easily be precisely reproduced and the causal parameters of the problem can be identified particularly precisely. This advantageously overcomes the disadvantage that hearing aid wearers—when visiting their hearing aid acoustician for readjustment—are frequently no longer able to remember the hearing situation that existed at the time of the problem sufficiently precisely.

Fundamentally, it is conceivable within the context of the invention for the control signal to be transmitted to the hearing aid by a magnetically or inductively based or radio-based (e.g. WLAN or Bluetooth) communication method. Preferably, however, the analysis unit (particularly all the software applications implemented for controlling the hearing aid on the smart phone or remote control) is set up to transmit the data and control commands to the hearing aid acoustically. In this case, in an expedient embodiment, the control signal is thus output to the hearing aid acoustically (i.e. as a sound signal) by a loudspeaker associated with the analysis unit. Preferably, this involves the use of a transmission frequency having a bandwidth of between approximately 12 and 16 kilohertz, particularly around 15 kilohertz, for the control signal.

In an expedient embodiment of the method, in addition to the wearer-specific problem, at least one sensor associated with the analysis unit is used to capture further data that are characteristic of the current situation of the hearing aid wearer (subsequently referred to as “situation data”) and the data are stored as a further part of the first data record element. Preferably, the sensor used in this case is a microphone (which is present anyway in the case of a smartphone). This microphone is used to capture in particular acoustic information, such as the (current) ambient volume (in the form of frequency-dependent levels) and possibly frequency fluctuations, as situation data. These (acoustic) situation data can in turn be expediently used during a later evaluation of the first and second data record elements in order to verify the operation of the classifier that may be present in the hearing aid. Additionally, the further situation data ascertained are also the current date and the time of day, for example. From these it is possible to infer a problem that may be dependent on the time of day during the later evaluation of the data record elements. As a further sensor, the invention can also involve the use of a GPS sensor (which is usually likewise present in a smartphone), for example, for ascertaining position data (as situation data). Fundamentally, it is particularly also conceivable within the context of the invention for the situation data ascertained by the additional sensor(s) to be made available to the manufacturer of the hearing aid (after being read from the analysis unit), so that the manufacturer can use the situation data for the development and (factory) presetting of hearing aids.

In order to ascertain, and in each case to be able to store (an associated first and second data record element), any further problems that arise between the occurrence of a “first” problem, the ascertainment thereof, described above, and storage of the two data record elements in the respective memory units, and the readjustment of the hearing aid settings (by the hearing aid acoustician), a particularly expedient embodiment of the method involves both the first data record element and the second data record element each being associated a marker. These two markers are used to explicitly (in particular temporally) associate the two data record elements with one another—i.e. the problem ascertained by the analysis unit and the operating data stored in that regard in the hearing aid. By way of example, the respective data record element is allocated a (shared) time stamp (i.e. date and time of day) as a marker. Preferably, however, the marker is an index that is the same for the first and for the second data record element, particularly a progressively increased counter, and that can be used for explicitly associating the two data record elements with one another for a particularly low memory requirement (and a low data transmission volume).

In a preferred embodiment, the marker for the second data record element or at least a command for generating the marker in a control unit of the hearing aid is transmitted from the analysis unit to the hearing aid by the control signal. By way of example, the marker directly transmitted is a numerical index from 1 to 20 or up to 50 (depending on the size of the memory unit and hence available storage locations for the data record elements). In an alternative embodiment, particularly in order to keep the information that needs to be transmitted by means of the control signal as little as possible, the command transmitted for generating the marker is merely a single-bit counter whose value is used by the control unit as an index. When an already allocated index is received again, a leading tens position is introduced for the index and/or possibly increased by 1. In other words, the analysis unit generates the marker by sending only digits from 0 to 9 and the control unit of the hearing aid produces the indices 0 to 9 first of all and then, on fresh reception of the digit 1, for example, the index 11, 21, etc.

In an expedient embodiment of the method, the hearing aid wearer is presented with a number of questions to answer by the analysis unit as part of a question-and-answer routine in order to ascertain the wearer-specific problem. In this case, these questions are taken particularly from a catalog of questions that is stored in (the memory unit of) the analysis unit. To answer, the hearing aid wearer is in this case preferably presented with answers (on the basis of a “multiple choice” principle or as a true or false selection). In this case, the question-and-answer routine is executed (in a known manner) such that the chosen response is taken as a basis for selecting a further question (leading toward a reduced selection of problems in comparison with the previous step) from the catalog of questions and presenting it to the hearing aid wearer. In this case, the catalog of questions is expediently geared to a number and selection, based particularly on empirical values, of possible, i.e. conventionally arising, problems of hearing aid wearers with the operating state of their hearing aid. Performance of the question-and-answer routine thus expediently involves the number of problems that possibly exist being restricted to an ever greater extent by the analysis unit, depending on the answers to the questions, until a specific problem has been ascertained. Preferably, following a final question, the problem ascertained by the analysis unit is presented to the hearing aid wearer for confirmation and only confirmation from the hearing aid wearer prompts the first data record element to be stored and the control signal to be output.

In order to achieve a particularly high level of user friendliness, the analysis unit additionally provides, in an expedient embodiment—particularly if the existing wearer-specific problem has not been able to be ascertained by the question-and-answer routine—, the hearing aid wearer (in order to confirm the stated problem) with an opportunity for direct input of a description of the problem perceived by the hearing aid wearer. Particularly if the analysis unit is implemented as a software application on a smartphone, the analysis unit does this by opening a text input window or providing an opportunity for voice input of the problem via the microphone of the smartphone. This allows even a previously unknown (or unstored) problem to be recorded in a simple manner.

Within the context of the invention, it is fundamentally conceivable for the question-and-answer routine to start automatically at prescribed intervals of time and/or after the current program has changed. In a preferred embodiment, the question-and-answer routine is started only in response to a command (i.e. in response to a corresponding input from the hearing aid wearer in the analysis unit), however.

Fundamentally, the invention can involve the second data record element stored in the hearing aid being all available operating data. In order to keep the memory requirement per (second) data record element as low as possible, however, only a (preferably firmly) prescribed number of operating data, which is restricted (i.e. reduced) in comparison with all the operating data available in the hearing aid, is used for the second data record element, however. These prescribed operating data are particularly those described above. Hence, the values of the same operating data are preferably always stored for each second data record element in the memory unit of the hearing aid. Expediently, the operating data that are to be stored as a second data record element are geared to the conventional problems (particularly also on which the catalog of questions in the analysis unit is based) of hearing aid wearers with their respective hearing aids. That is to say that the operating data to be stored are the relevant operating data which are causal for these conventional problems and hence required in order to overcome these problems.

In an alternative embodiment, the respectively ascertained problem is taken as a basis for selecting a restricted number (in comparison with the total number) of operating data from all the operating data that are present in the hearing aid and using it for the second data record element (on a problem-specific basis). Within the context of the invention, it is conceivable in this case for the selection of the operating data for storage to be made in the analysis device itself, or for, alternatively, the ascertained problem to be transmitted (as the information content of the control signal) to the hearing aid and for the respective selection of the operating data for storage to be made by the control unit of the hearing aid.

The method according to the invention for adjusting (hearing aid) settings of the hearing aid, particularly for readjusting (“recalibrating”) the settings (parameters) of the hearing aid, involves the method described above for ascertaining the use data having a further method step added. In this case, a setting unit that is set up for bidirectional communication with the hearing aid and with the analysis unit is used to capture a wearer-specific use data record for the hearing aid. This use data record is the first data record element and the associated second data record element. These two data record elements are read by the setting unit from the analysis unit and from the hearing aid (particularly from the respective memory units) in each case. To form the use data record, the first data record element is then connected to the associated second data record element, preferably on the basis of their associated markers. In a subsequent step, the two data record elements are evaluated together. On the basis of the result of the evaluation, new settings are ascertained (particularly by the setting unit automatically) for the hearing aid and, preferably in response to a confirmation (that is provided particularly by the hearing aid acoustician), transmitted to the hearing aid.

The storage of the (problem-based) use data and the later retrieval thereof by means of the setting unit allow simple and precise ascertainment and adjustment of the current parameters of the hearing aid, that is to say of the existing hearing aid settings. In particular, the hearing aid acoustician and/or the setting unit can take the operating data stored in the hearing aid as a basis for simulating the hearing situation that exists at the time of identification of the problem particularly precisely, without being reliant on the usually comparatively imprecise powers of recollection of the hearing aid wearer.

The bidirectional communication between the setting unit and the hearing aid or the analysis unit is effected preferably by wire. Alternatively, the invention can also involve wireless, in particular radio-based, communication in each case.

If the hearing aid contains a classifier for ascertaining (“classifying”) the current hearing situation and the analysis unit also stores situation data about the ambient volume (and possibly frequency fluctuations) in the first data record element, the setting unit is used, in one expedient embodiment, to determine a (comparison) hearing situation from the acoustic situation data stored by the analysis unit and the hearing situation is compared with the (hearing-aid-specific) hearing situation ascertained by the classifier at the time of the problem. Preferably, any hearing situations that differ from one another give rise to the output of a warning. Within the context of the invention, it is conceivable in this case for this warning to prompt the setting unit to automatically ascertain new settings for the classifier and to propose (preferably to the hearing aid technician) the settings for adjustment of the hearing aid. Alternatively, but preferably at least before confirmation of the transmission of the new settings for the classifier to the hearing aid, the hearing aid examiner can (in particular manually) use the acoustic data captured by the hearing aid to check whether the hearing situation ascertained by the hearing aid is plausible in the present case (for example if the acoustic data captured by the analysis unit differ from those of the hearing aid and this is the actual reason why different hearing situations are ascertained).

The hearing aid system according to the invention contains the hearing aid, which may be formed either by a single hearing aid or by a (binaural) pair of hearing aids, and the (separate) analysis unit, which is in particular specifically associated with the hearing aid. As described above, the analysis unit is set up only for unidirectional signal transmission to the hearing aid in this case. The hearing aid and the analysis unit are set up and provided, particularly in terms of software, for (joint) performance of the method described above for ascertaining the wearer-specific use data for the hearing aid. In other words, the analysis unit is set up to ascertain a wearer-specific problem with the current operating state of the hearing aid, to store the problem in an associated memory unit as a first data record element and then to send a preferably acoustic control signal to the hearing aid. The hearing aid preferably contains a control unit that is set up to ascertain, in response to reception of the control signal, a number of operating data for the current operating state of the hearing aid and to store the number of operating data in an associated memory unit as a second data record element.

The setting unit according to the invention for the hearing aid system described above contains a respective (physical or radio-based) interface for coupling (for the purposes of information transmission) to the analysis unit and to the hearing aid and is set up to perform the method described above for adjusting the hearing aid settings. Within the context of the invention, the setting unit may be in the form of a nonprogrammable electronic circuit in this case and, in so being, form an apparatus that is configured specifically for adjusting hearing aids, for example. Preferably, however, the setting unit is formed by a microcontroller in which the functionality for performing the method according to the invention for adjusting the hearing aid settings is implemented in the form of a software module. By way of example, the microcontroller is part of a computer that is set up and provided for physical or wireless connection to the analysis unit and to the hearing aid. In particular, the setting unit is therefore set up to be connected to the hearing aid and the analysis unit for the purposes of information transmission, and then to retrieve (read) the first and second data record elements from the analysis unit and the hearing aid, to connect the data record elements to one another and to evaluate them. For the purposes of evaluation, the setting unit is preferably set up to automatically take the operating data that the second data record element contains as a basis for simulating a hearing situation, to collate the hearing situation with the ascertained problem and to take this collation as a basis for ascertaining new parameterization (new settings) for the hearing aid. Expediently, the setting unit is likewise set up to transmit these new settings (in response to a confirmation particularly by the hearing aid acoustician) to the hearing aid.

Conventionally, the setting unit forms part of the hardware and/or software equipment of a hearing aid acoustician, since operation thereof and particularly knowledge of the hearing aid settings require the special training and experience of a hearing aid acoustician. Therefore, the methods and apparatuses described above afford the advantage that the hearing aid wearer does not need to remember (or possibly write down) a problem, when said problem exists, until his next visit to the hearing aid acoustician. Furthermore, the operating data stored in the hearing aid provide the hearing aid acoustician with a large amount of information, so that he can perform particularly precise adjustment of the settings of the hearing aid.

Other features which are considered as characteristic for the invention are set forth in the appended claims.

Although the invention is illustrated and described herein as embodied in a method for ascertaining wearer-specific use data for a hearing aid, a method for adapting hearing aid settings of a hearing aid, a hearing aid system and a setting unit for a hearing aid system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic illustration of a hearing aid system and a setting unit for the hearing aid system according to the invention;

FIG. 2 is a flowchart showing a method for ascertaining wearer-specific use data for the hearing aid; and

FIG. 3 is a flowchart based on FIG. 2 of a method for adjusting hearing aid settings of the hearing aid by the setting unit.

### DETAILED DESCRIPTION OF THE INVENTION

Mutually corresponding parts and variables are always provided with the same reference symbols throughout the figures.

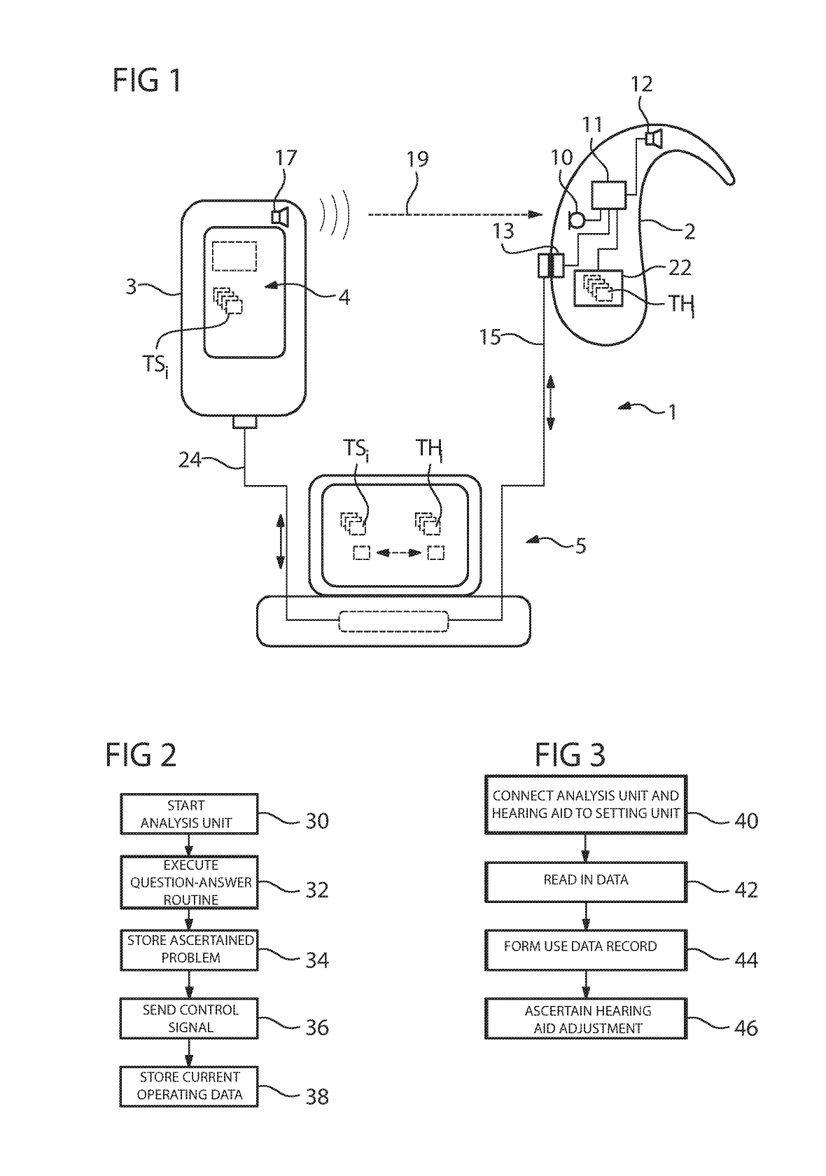

Referring now to the figures of the drawings in detail and first, particularly to FIG. 1 thereof, there is shown a hearing aid system 1 that contains a hearing aid 2 and an analysis unit 4, the latter being installed as a software application so as to be executable on a smartphone 3. Furthermore, FIG. 1 shows a setting unit 5 that is in the form of a software application, which is installed so as to be executable on a computer, and is set up to be connected for bidirectional communication with the analysis unit 4 and the hearing aid 2.

In the exemplary embodiment shown, the hearing aid 2 is in the form of a single “behind-the-ear” (BTE, for short) hearing aid. Instead of such a BTE hearing aid, the hearing aid 2 within the context of the invention may also be in the form of an in-the-ear hearing aid, as an implantable hearing aid or the like, however. Furthermore, the hearing aid 2 may also be in the form of a pair of hearing aids for catering for the binaural needs of both ears of the hearing aid wearer. The hearing aid 2 contains a microphone 10 for receiving acoustic signals, a control unit 11 for signal processing for the received acoustic signals and a loudspeaker 12 (also referred to as “earphone”) for acoustically transferring the (sound)signals processed in the control unit 11 to an ear of the hearing aid wearer. For the purpose of (bidirectional) data transmission to the setting unit 5, the hearing aid 2 additionally contains a data interface 13. In this case, the data interface 13 contains a plug connection for making contact with a data cable 15 that is used to set up the communication link to (a corresponding data interface of) the setting unit 5.

In contrast to the setting unit 5, the analysis unit 4 is configured only for unidirectional communication with the hearing aid 2. In other words, the analysis unit 4 can only transmit data (particularly commands) to the hearing aid 2, without the existence of or even provision for a flow of information in the opposite direction. For the purpose of data transmission to the hearing aid 2, a loudspeaker 17 of the smartphone 3 is in this case used to output acoustic signals to the hearing aid 2, specifically to the microphone 10 thereof. In this case, these acoustic signals have a transmission bandwidth that is only small in comparison with the radio-based data transmission, so that only short data records (i.e. having a comparatively small information content) can be transmitted. The smartphone 3 is set up by the installed analysis unit 4 to use a method that is described in more detail below to ascertain a (subjective) problem of the hearing aid wearer with the current operating state of the hearing aid 2 and then to use the loudspeaker 17 of the smartphone 3 to output an acoustic control signal 19 to the hearing aid 2. The method is used to ascertain (hearing-aid) wearer-specific use data for the hearing aid 2 and hence to facilitate and improve a subsequent adjustment (in comparison with a previous adjustment of the hearing aid settings, particularly by the hearing aid acoustician) of the hearing aid setting.

First of all, the hearing aid system 1 is used—as shown in FIG. 2—to perform a method for ascertaining the wearer-specific use data. To this end, in the event of the hearing aid wearer having a problem with the operating state of his hearing aid 2, the hearing aid wearer starts the analysis unit 4 on his smartphone 3 in a first method step 30. The analysis unit 4 then executes a question-and-answer routine in a second method step 32 by presenting the hearing aid wearer with a number of questions that are stored in a catalogue of questions. In this case, the questions are geared to known problems of hearing aid wearers that are related to different operating states of the hearing aid. Thus, the hearing aid wearer is first of all presented with comparatively general questions that are used for coarse selection of possible problems. On the basis of the response (particularly “true” or “false”), the hearing aid wearer is then presented with a question (more specific in comparison with the preceding one) to answer. The following order is conceivable as an exemplary question-and-answer sequence:
Question: Does the problem relate to your own voice? (possible answer selection: true/false)
Answer: True.
Question: Does the problem relate to the volume?
Answer: True.
Question: Is your own voice too loud?
Answer: False.
Question: Is your own voice too quiet? Etc.

At the end of this question-and-answer routine, the hearing aid wearer is presented with the ascertained problem (for example, in the present example: “your own voice is heard too quietly”) as the result for confirmation. If the hearing aid wearer does not provide positive confirmation of the selected/ascertained problem (by particularly choosing “false” as an answer), the question-and-answer routine is restarted. As an alternative (or even in addition, within the context of the invention) to restarting the question-and-answer routine, a text input window is opened on the smartphone 3 and proffered to the hearing aid wearer for manual input of the problem, so that the hearing aid wearer can also input a different problem than the stored “sample problems”. Positive confirmation of the problem (or possibly a manual input) prompts the analysis unit 4 to store the ascertained problem in a first data record element TSᵢ in a memory unit associated with the analysis unit 4 in a further method step 34. In this case, the analysis unit 4 allocates the index i to the first data record element TS; as a marker, the index being able to assume progressive integer values i=0, 1, 2, . . . , n.

In a subsequent method step 36, the analysis unit 4 activates the loudspeaker 17 of the smartphone 3 and uses it to send the control signal 19 to the microphone 10 of the hearing aid 2. For the purpose of explicitly associating the control signal 19 with the hearing aid 2, an address individually geared to the hearing aid 2 is transmitted in the control signal 19. Similarly, the index i allocated for the currently stored first data record element TSᵢ is transmitted in the control signal 19. On reception and identification of the control signal 19 on the basis of the transmitted address, the control unit 11 stores a prescribed selection of current operating data for the hearing aid 2 as a second data record element THᵢ in a memory unit 22 associated with the control unit 11 in a method step 38. In this case, the control unit 11 allocates the index i transmitted with the control signal 19 to the second data record element THᵢ.

In this case, the number and selection of the operating data stored in the second operating data record THᵢ is firmly prescribed and is restricted in comparison with the operating data than are present in the hearing aid 2, specifically in the control unit 11. Specifically, only such operating data as are required for rectifying all the problems—on which the catalog of questions is based—of the hearing aid wearer with the operating state of the hearing aid 2, and/or are relevant to the most precise possible determination of the hearing situation existing at the time of the storage, are stored. To this end, operating data, such as the input levels picked up by the microphone 10 for different frequencies, the (hearing) program currently performed by the control unit 11 (e.g. “television”, “conversation with ambient noise”, etc.), the volume and balance (latter in the case of a pair of hearing aids) currently set by the hearing aid wearer, are used. As part of the respective program, the respective settings (parameters) for frequency-dependent gain, compression and/or attenuation of the input signals are also stored. For the selection of the program, the hearing aid 2 (specifically the control unit 11) contains a classifier that takes the frequency-dependent input levels of the microphone 10 as a basis for determining a hearing situation and, in an automatic mode of the hearing aid 2, automatically sets the program corresponding with the hearing situation. The hearing situation (“classification”) determined by the classifier is likewise stored in the second operating data record THᵢ. As an alternative to the automatic mode, the control unit 11 also contains a manual mode, in which the hearing aid wearer can also set the program manually.

The paired allocation of the indices i allows the analysis unit 4 to be used to ascertain problems repeatedly in succession. In this case, the associated data record elements TSᵢ and THᵢ are stored with a respective progressively increased index. This allows an explicit (temporal) association between the respective first and second data record elements TSᵢ and THᵢ.

In a (further) method (shown in FIG. 3) for (subsequently) adjusting the hearing aid settings of the hearing aid 2, a method step 40 involves the analysis unit 4 and the smartphone 3 being connected by means of a data cable 24, and the hearing aid 2 being connected by a data cable 15, to the respectively corresponding data interface of the setting unit 5. A subsequent method step 42 involves the setting unit 5 reading the first data record element TSᵢ (if need be all first data record elements TSᵢ) from the analysis unit 4 and accordingly the second data record element THᵢ (or all second data record elements THᵢ) from the hearing aid 2. The setting unit 5 then connects the respective identifiable—on the basis of the index i—first data record element TSᵢ to the associated second data record element THᵢ (and therefore forms a use data record) in a method step 44 and evaluates them. The evaluation contains a reconstruction of the hearing situation that exists at the time of storage on the basis of the operating data of the hearing aid 2 that are stored in the second data record element THᵢ, and collation of this hearing situation with the problem that the hearing aid wearer has at the present time. This makes it a particularly simple matter to establish the cause of the problem and to make appropriate changes for the hearing aid settings.

The setting unit 5 is additionally set up to ascertain an adjustment for the hearing aid settings in a method step 46 on the basis of the ascertained problem and the reconstructed hearing situation, to propose the adjustment (to the hearing aid acoustician) and, on confirmation, to transmit it to the hearing aid 2. If a plurality of first and second data record elements TSᵢ and THᵢ are stored, method steps 44 and 46 are accordingly performed repeatedly. In addition, after reading the first and second data record elements TSᵢ and THᵢ, the setting unit 5 erases them from the respective memory units of the analysis unit 4 and the hearing aid 2 and resets the respective index i.

In a further exemplary embodiment, which is not shown in more detail, the analysis unit 4 uses a microphone of the smartphone 3 to additionally capture the (frequency-dependent) ambient sounds in method step 32 and likewise stores them as part of the first data record element TSᵢ. In method step 44, the setting unit 5 then reconstructs a hearing situation on the basis of these ambient sounds—captured by the smartphone 3—and compares the hearing situation with a hearing situation that is output by a classifier of the hearing aid 2 (on the basis of the sound signals captured by the microphone 10) and stored in the second data record element TRᵢ. This allows verification of the operation of the classifier and if need be adjustment of the settings of the classifier.

In an alternative exemplary embodiment, which is likewise not shown, the data interface 13 of the hearing aid 2 is set up for wireless, radio-based communication with the setting unit 5.

Although the subject matter of the invention is particularly clear from the exemplary embodiment described above, the subject matter of the invention is not limited to the exemplary embodiment described above. Rather, it is possible for further embodiments of the invention to be derived from the above description by a person skilled in the art.

1. A method for ascertaining wearer-specific use data for a hearing aid, which comprises the steps of:
using an analysis unit, being specifically associated with the hearing aid, formed separately therefrom and set up for unidirectional signal transmission to the hearing aid, to ascertain a wearer-specific problem with a current operating state of the hearing aid;
storing the wearer-specific problem ascertained in a memory unit, associated with the analysis unit, as part of a first data record element of the use data;
prompting a control signal to be output to the hearing aid upon ascertainment of the wearer-specific problem; and
prompting, upon a reception of the control signal, a number of operating data for the current operating state of the hearing aid to be ascertained and stored in a memory unit of the hearing aid as a second data record element of the use data, wherein the first data record element and the second data record element remain stored in a respective said memory unit even after a change in the current operating state of the hearing aid.

2. The method according to claim 1, which further comprises outputting the control signal acoustically by means of a loudspeaker associated with the analysis unit.

3. The method according to claim 1, which further comprises using at least one sensor associated with the analysis unit to ascertain data that are characteristic of a current situation of a hearing aid wearer and the data are stored in the first data record element of the use data.

4. The method according to claim 1, which further comprises assigning each of the first data record element and the second data record element a marker, the two markers being used to explicitly associate the first data record element and the second data record element with one another.

5. The method according to claim 4, wherein the analysis unit uses the control signal to transmit the marker for the second data record element to the hearing aid.

6. The method according to claim 1, wherein the ascertainment of the wearer-specific problem involves the analysis unit presenting a hearing aid wearer, in a course of a question-and-answer routine, with a number of questions to answer from a prescribed catalog of questions that is stored in the analysis unit.

7. The method according to claim 6, which further comprises starting the question-and-answer routine in the analysis unit in response to an input by the hearing aid wearer.

8. The method according to claim 1, which further comprises using a prescribed number of operating data, which is restricted in comparison with all operating data that are present in the hearing aid, for the second data record element.

9. The method according to claim 1, which further comprises taking the wearer-specific problem as a basis for selecting a restricted number of operating data from all the operating data that are present in the hearing aid and using it for the second data record element.

10. A method for adapting hearing aid settings of a hearing aid, which comprises the steps of:
using a setting unit, being set up for bidirectional communication with the hearing aid and with an analysis unit associated with the hearing aid, to capture wearer-specific use data of the hearing aid which have been ascertained using a method according to claim 1, by virtue of the first data record element of the use data being read from the analysis unit and the second data record element of the use data being read from the hearing aid;
connecting the first data record element to the second data record element associated to the first data record element;
subsequently evaluating the first and second data record elements together; and
using a result of an evaluation to ascertain new settings for the hearing aid and transmitting them to the hearing aid.

11. A hearing aid system, comprising:
a hearing aid;
an analysis unit specifically associated with said hearing aid, formed separately from said hearing aid and set up for unidirectional signal transmission to said hearing aid; and
said hearing aid and said analysis unit programmed to perform the method according to claim 1.

12. A setting unit for a hearing aid system having an analysis unit and a hearing aid, the setting unit comprising:
a respective data interface for coupling to the analysis unit and to the hearing aid, the setting unit programmed to perform a method according to claim 10.
